(19) United States
(12) Patent Application Publication
(10) Pub. No.: US 2003/0230837 A1
(43) Pub. Date: Dec. 18, 2003

(54) Bar clamp corner squaring fixture

(76) Inventor: Howard Francis Gokey, Malone, NY (US)

Correspondence Address: HOWARD F. GOKEY, 25 EDWARD ST., MALONE, NY, 12953, US

(21) Appl. No.: 10/084,786

(22) Filed: Jun. 14, 2002

(51) Int. Cl. B25B 1/02

(52) U.S. Cl. 269/204

(57) ABSTRACT

The Bar Clamp Corner Squaring Fixture can be used primarily for clamping and holding picture frames in a completely square position while the glue that is used to attach them together dries.

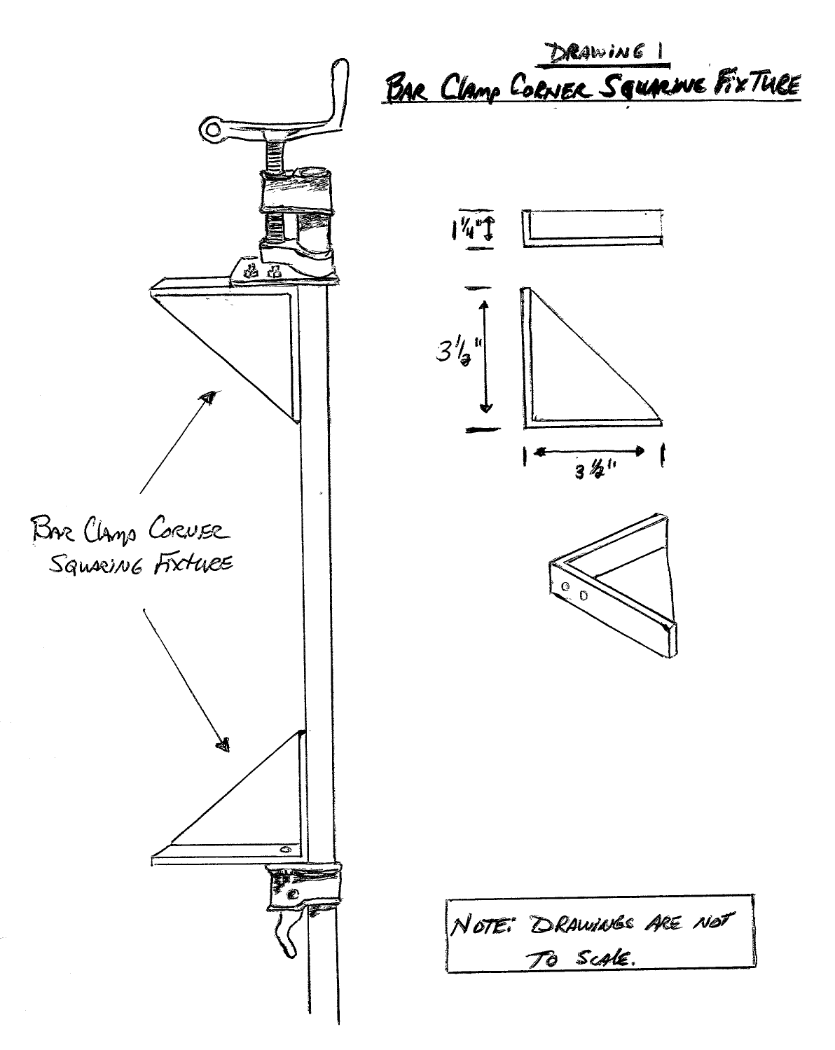

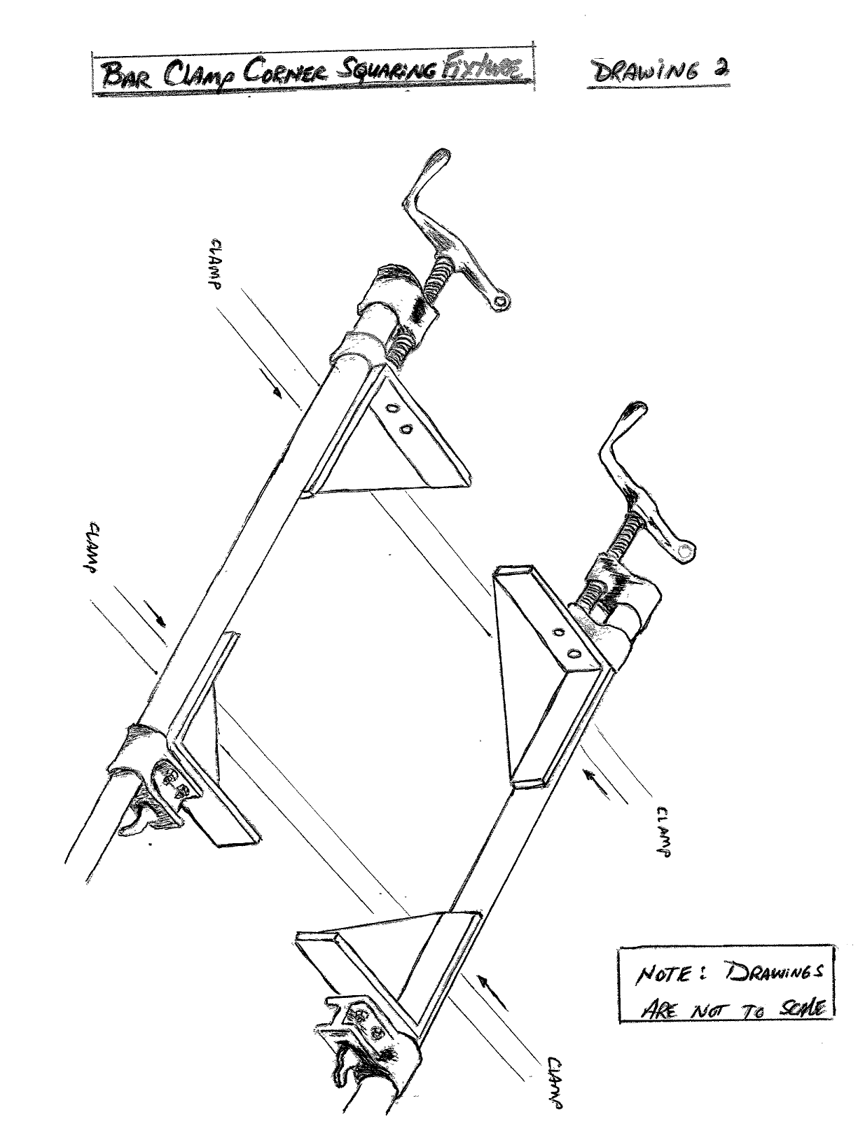

The clamps provide a unique method of using existing bar clamps to perform the function and do not require a lot of minute hand adjustments to move to different size frames. Use of the Bar Clamp Corner Squaring fixture also provides the ability to hold both small and large size frames with a larger holding surface than some existing methods.

In addition to the primary function, the Bar Clamp Corner Squaring Fixture is versatile enough to allow other objects to be squared up for gluing or nailing.

### SPECIFICATION OF INVENTION

The invention consist of four (4) pieces of metal fabricated to 90 degree corners and is used in conjunction with standard bar clamps. The manner in which they would be used is shown in drawings 1 and 2 which are attached to this application.

The metal fixtures are made from ⅛″ band iron and are welded in the corners and at the base.

The fixtures are 1¼″ high and each side is 3½″ long.

The four (4) corner pieces were designed to be used to hold picture frames in place and in square to allow them to be glued. Cardboard or paper can be placed over the fixtures to prevent excess glue from getting on the fixtures.

Drawing 1 shows the fixtures separately and on one bar clamp.

Drawing 2 shows all four fixtures in place and how they would be clamped with four bar clamps.

Holes would be drilled in the fixtures to allow for them to be permanently attached to two bar clamps. This would be optional and would not be required for the fixtures to work properly.

1. I claim that the Bar Clamp Corner Squaring Fixture can be used to clamp picture frames in a completely square position while the glue that is used to attach them together dries
